(19) United States
(12) Patent Application Publication
(10) Pub. No.: US 2013/0333483 A1
(43) Pub. Date: Dec. 19, 2013

(54) METHODS AND APPARATUS FOR DETECTION OF FLUID INTERFACE FLUCTUATIONS

(71) Applicants: Kirill Horoshenkov, Ilkley (GB); Andrew Nichols, Skipton (GB)

(72) Inventors: Kirill Horoshenkov, Ilkley (GB); Andrew Nichols, Skipton (GB)

(73) Assignee: University of Bradford, Bradford (GB)

(21) Appl. No.: 14/002,569

(22) PCT Filed: Mar. 5, 2012
(86) PCT No.: PCT/GB2012/050489

§ 371 Date: Aug. 30, 2013

(30) Foreign Application Priority Data
Mar. 3, 2011 (GB) 1103642.3

(51) Int. Cl. G01F 1/66

(52) U.S. Cl. CPC G01F 1/66
USPC 73/861.25

(57) ABSTRACT

Dynamic characteristics of a liquid surface (160) are measured by sending acoustic signals (140) to or more target areas (162a-162c) on the liquid surface and receiving said acoustic signals (150a-150c) after reflection from the target area. The detected signals are processed to measure phase shift between the sent and received acoustic signals, the measured phase shift varying over time. The varying phase shift is used to indicate fluctuations over time in the local height of the liquid surface in the target area. The liquid may be water, effluent etc. flowing in a channel or conduit. With suitable calibration, the measured height fluctuations can be used to infer flow characteristics such as surface roughness, wave height, flow depth, flow velocity, volumetric flow rate, shear stress, sediment transport. Using an array of receivers and target areas, additional spatial and temporal characteristics of the surface and the flow can be measured.

### FIELD

The present invention relates generally to acoustic technologies, and more particularly to methods and apparatus for detection of fluctuations in an interface between two fluids. The invention further relates to processors and computer program products adapted for use in such methods.

### BACKGROUND

An example of an interface between two fluids is the free surface of a liquid (first fluid) under a gaseous atmosphere (second fluid). The liquid may be relatively static, with surface fluctuations caused by wind, for example. The liquid may be flowing in a conduit or channel with surface fluctuations (waves) caused additionally by turbulence. It is important to monitor flow conditions of free-surface flow in a number of applications, such as river flood monitoring, flow control in water and waste treatment, petrochemical and food processing plants.

It has been disclosed by Nichols, A. et al, in Sonic Characterisation of Water Surface Waves, ISPF2010, Nanjing, China in 2010, and by Liu, H.-T., K. B. Katsaros and M. A. Weissman in Dynamic Response of Thin-Wire Wave Gauges, J. Geophys. Res., 87(C8), 5686-5698 in 1982 that detailed surface fluctuations can be captured by use of invasive conductance probes. However, these probes may collect debris in the flow and generate their own surface fluctuations which can obscure data.

It is known to use ultrasonic devices to gauge the relative position of a water surface in order to calculate depth. These operate with airborne acoustic signals to measure the surface height in a static or average way, for example to measure the fill state of a storage tank, or the state of a tide. Airborne Doppler techniques are known to be used to quantify the horizontal component of surface velocity of water flows. Other airborne time-of-flight acoustic range finding techniques have been used to measure the static level of water by emitting short pulses (e.g. N. A. Bolton, Liquid Level Indication System, U.S. Pat. No. 3,184,969, Jun. 10, 1963; S. D. Lenz, R. Hulinsky, Ultrasonic Level Measuring System, U.S. Pat. No. 5,319,974, Jun. 14, 1994, and also GB 1600079, GB 2188420A, GB 2472085A, US 2006/0037392A1). Some underwater acoustic techniques have been known to measure the statistical roughness of a water surface, for example to monitor sea state at offshore locations. An example is the work by E. I. Thorsos, “The validity of the Kirchhoff approximation for rough surface scattering using a Gaussian roughness spectrum”, J. Acoust. Soc. Am., 83(1), 78-92 (1988). An ultrasonic device for measuring surface roughness of mechanical components is disclosed in U.S. Pat. No. 4,364,264.

None of the known acoustic devices offers the ability to measure detailed local surface fluctuations at a fluid interface, in a way that could allow them to replace the invasive conductance probes in the investigation and monitoring of flow conditions.

### SUMMARY

Various embodiments of the present invention provide non-invasive methods and systems for detection of fluctuations in fluid interfaces such as free surfaces of flowing liquid, thereby to address one or more of the drawbacks of the aforementioned prior art.

According to a first aspect of the invention, there is provided a method for measuring dynamic characteristics of an interface between two fluids, the method comprising:
sending acoustic signals from an acoustic source to at least one target area on the fluid interface;
receiving said acoustic signals at an acoustic receiver after reflection from the target area; and,
processing the detected signals to measure phase shift between the sent and received acoustic signals, the measured phase shift varying over time, and using the variations in phase shift to indicate fluctuations over time in the position of the fluid interface in the target area.

To allow accurate indication of dynamic, local fluctuations, the target area can be designed to have a size smaller than a dominant spatial scale of said localised fluctuations at the interface.

In a particular application of the method, said two fluids are a gas (which includes a vapour) and a liquid, said interface being a free surface of the liquid, the acoustic source and receiver being positioned above the liquid surface, the variations in phase shift being used indicate fluctuations over time in the height of the liquid surface.

The liquid may be flowing in a natural or man-made channel or conduit. In embodiments of the invention the method further comprises deriving from the measured variations in phase shift a characteristic of the flowing liquid such as: surface roughness, wave height, flow velocity, volumetric flow rate, shear stress, sediment transport.

The sent acoustic signals may comprise a harmonic sine wave. Said processing step may comprise comparing phases of the sent and received signals over several cycles of said sine wave to obtain a measurement of said phase shift at a given time.

The phase shift may be is determined on the basis of Hilbert transforms of data representing the sent and detected acoustic signals.

The method may further comprise arranging a plurality of acoustic receivers at different positions relative to the acoustic source so as to receive acoustic signals that have reflected simultaneously from different target areas on the fluid interface and processing the received acoustic signals so as to measure a time-varying phase shift corresponding to each of said target areas. The plurality of receivers may be spaced to allow different separation distances between different pairs of the receivers. The plurality of receivers may be spaced in two dimensions so that said different target areas are spaced in two dimensions over the fluid interface.

The method may further comprise measuring a temporal lag between fluctuations measured for different target areas (i.e. by different receivers). A flow velocity may be derived from the temporal lag and from knowing the distance between the target areas in a direction fo fluid flow.

The method may further comprise determining a wave height at the target area on the basis of the measured variations in phase shift, a known separation of the acoustic source and receiver and a known receiver height relative to said interface. Said known receiver height may be obtained by measuring a time of flight of an acoustic signal sent from said acoustic source, and received by said acoustic receiver following reflection from the interface.

The invention further provides apparatus as defined in the appended claims, which may be used to perform the methods of the invention, as set forth above.

In another aspect of the invention, a method for detecting liquid surface fluctuations comprises: sending acoustic signals from a first known point to a point on a liquid surface; receiving said acoustic signals at a second known point after reflection from the liquid surface; processing the detected signals periodically to monitor variations in phase shift between the sent and received acoustic signals, and using the variations in phase shift to indicate fluctuations in the height of the liquid surface at the point.

According to another aspect of the invention, a system for detecting liquid surface fluctuations comprises: a signal emission module operable to send acoustic signals from a first known point to a point on a liquid surface; a signal detection module operable to receive said acoustic signals at a second known point after reflection from the liquid surface; and a processing module operable to process the detected signals periodically to monitor variations in phase shift between the sent and received airborne acoustic signals, and using the variations in phase shift to indicate fluctuations in the height of the liquid surface at the point.

According to yet another embodiment of the invention, there is provided a processor operable to process sent and received acoustic signals of the above method for detecting fluid interface liquid surface fluctuations.

According to yet another embodiment of the invention, there is provided a computer-readable medium including instructions which when executed by a computer can process sent and received acoustic signals of the above method for detecting liquid surface fluctuations.

The above and other aspects, features and advantages of the invention will be understood by the skilled reader from a consideration of the following detailed description of exemplary embodiments.

### BRIEF DESCRIPTION OF THE DRAWINGS

Embodiments of the invention will now be described, by way of example only, with reference to the accompanying schematic drawings in which corresponding reference symbols indicate corresponding parts.

FIG. 1 is a schematic side view of an exemplary system for detecting liquid surface fluctuation according to one embodiment of the present invention.

FIG. 2 shows an example of a signal detection module having a plurality of receivers to receive acoustic signals in (a) schematic side view and (b) and (c) plan views of different variants.

FIG. 3 is a flowchart of an exemplary method for detecting liquid surface fluctuation according to one embodiment of the present invention.

FIG. 4 is a flowchart of an exemplary method for detecting liquid surface fluctuation according to another embodiment of the present invention.

FIG. 5 is a flowchart of an exemplary method for determining the height of signal detection module above the liquid surface, usable in the methods of FIGS. 3 and 4.

FIG. 6 is an explanatory illustration of path lengths of two acoustic signals travelling from the signal emission module 110 to the signal detection module 120.

FIG. 7 is a set of graphs showing the water surface fluctuation Y over time X as measured by a conventional conductance probe and by an acoustic probe forming an embodiment of the present invention.

FIG. 8 is a set of graphs demonstrating the relationship of the measured water surface RMS surface roughness a to (a) mean flow velocity v and (b) hydraulic roughness kₛ.

FIG. 9 is a graph showing correlation coefficients varying with receiver separation.

FIG. 10 demonstrates a relationship between volumetric flow rate F and measured water surface roughness.

FIG. 11 demonstrates relationships between depth of flowing water and measured water surface roughness, for various bed gradients.

FIG. 12 demonstrates a relationship between flow surface characteristic period P and shear stress T at a channel bed.

### DETAILED DESCRIPTION OF EXEMPLARY EMBODIMENTS

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiments may be practiced without these specific details. In other instances, well-known structures and devices are shown in block diagram form in order to facilitate describing one or more embodiments.

While the invention may be applied generally to any interface between two fluids, the examples will use the practical example of a free surface of a liquid, that is to say the interface between a body of liquid such as water and a body of gas above it, for example the open atmosphere or atmosphere above the liquid within a closed conduit.

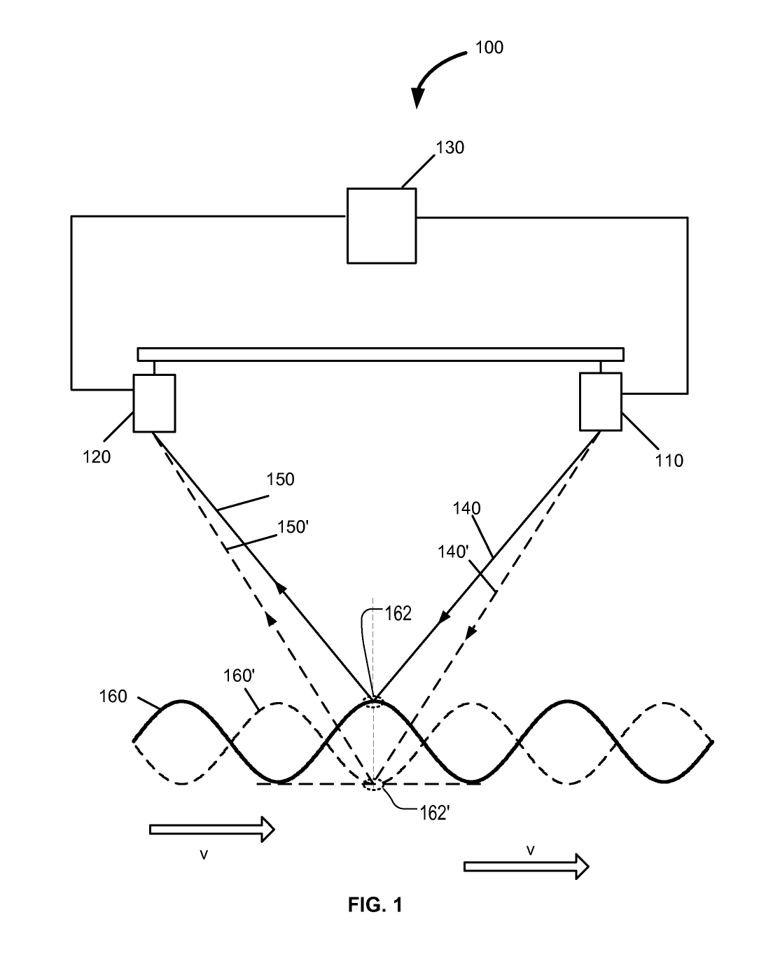

FIG. 1 shows an exemplary system 100 for detecting liquid surface fluctuation in accordance with various embodiments presented therein. System 100 comprises a signal emission module (emitter for short) 110, a signal detection module (receiver for short) 120 and a processing module 130. System 100 can be deployed to detect fluctuations in the height at a point 162 on a liquid surface 160. The fluctuation over time may be represented by as a wave height at the point 162. In practice, point 162 will not be an infinitely small point, but rather a target area. By suitable design of the system, the size of the target area can be made small relative to the surface fluctuations that are to be monitored, as discussed further below. System 100 may be positioned above the liquid surface 160 or below the liquid surface 160. In one embodiment, system 100 is operable to perform airborne acoustic inspection of hydraulic flow in shallow water channels, rivers, partly filled pipes and other unpressurised conduits. A flow with velocity v is indicated schematically by an arrow. The modules 110 and 120 may be mounted beneath a bridge over a river, in the roof of a conduit, or on their own platform, according to convenience. In practice, the fluctuations caused by turbulence and other mechanisms in such a real-world system will be more complex and three-dimensional than the simple wave shape shown in FIG. 1. Also, the height of the fluctuations is greatly exaggerated in FIG. 1, relative to the scale of the apparatus as a whole.

Signal emission module 110 comprises a signal generator and a transducer operable as an acoustic source to emit one or more airborne acoustic signals. Receiver 120 comprises a microphone or other transducer operable as an acoustic receiver to detect the one or more acoustic signals after reflection from a small target area the liquid surface. Processing module 130 is capable of data communication with emitter 110 or receiver 120 via a cable or wirelessly. For example, wireless data communication may be a short range wireless communication via a short distance data transmission technology standard such as Bluetooth ®. Processing module 130 may be a mobile personal computer, a handheld device or other computing device.

In an embodiment, emitter 110 is mounted at an angle between ten and eighty degrees to the horizontal, which may, for example, be approximately forty-five degrees. The emitter 110 may include an array of acoustic transducers, each of which is operable to emit an acoustic signal. In that case, controlling the relative phases of the emitted signals allows the direction and directivity of the acoustic signal to be controlled. Actively steering the beam is an option, for example to adjust for different surface heights, though it would add to cost and may reduce robustness of a device. Alternatively, one can design the geometry of the emitter-receiver arrangement such that the receiver is within the reflected beam for all reasonable flow depths, and use active steering when this is not possible.

In operation. processing module 130 controls emitter 110 to emit acoustic signals 140 over an extended period of time Processing module 130 triggers receiver 120 to receive airborne acoustic signals 150 reflecting back from surface 160 and processes the received signals on a continuous or pseudo-continuous basis. The signals follow different paths as the surface moves over time. The surface at different times may have different shapes illustrated by the solid and broken curves 160 and 160′. Correspondingly, the path of the acoustic signals may be as shown in the solid lines 140 & 150 at one time, and as shown by the broken lines 140′ & 150′ at another time.

The signal emission module (emitter) 110 in a simple embodiment emits a continuous ultrasonic sine wave at the resonant frequency of emitter 110 such as 45 kHz, and at an angle of, for example, 45 degrees to the horizontal. For example, the emitted acoustic signal may be configured to be a monochromatic sine wave at the resonant frequency of the transducer. The wavelength (λ) of the acoustic signal may be selected to be comparable with the maximum amplitude of the water surface roughness or greater than the root mean square of the water surface roughness height (λ≧σ), and a continuous harmonic signal may be emitted.

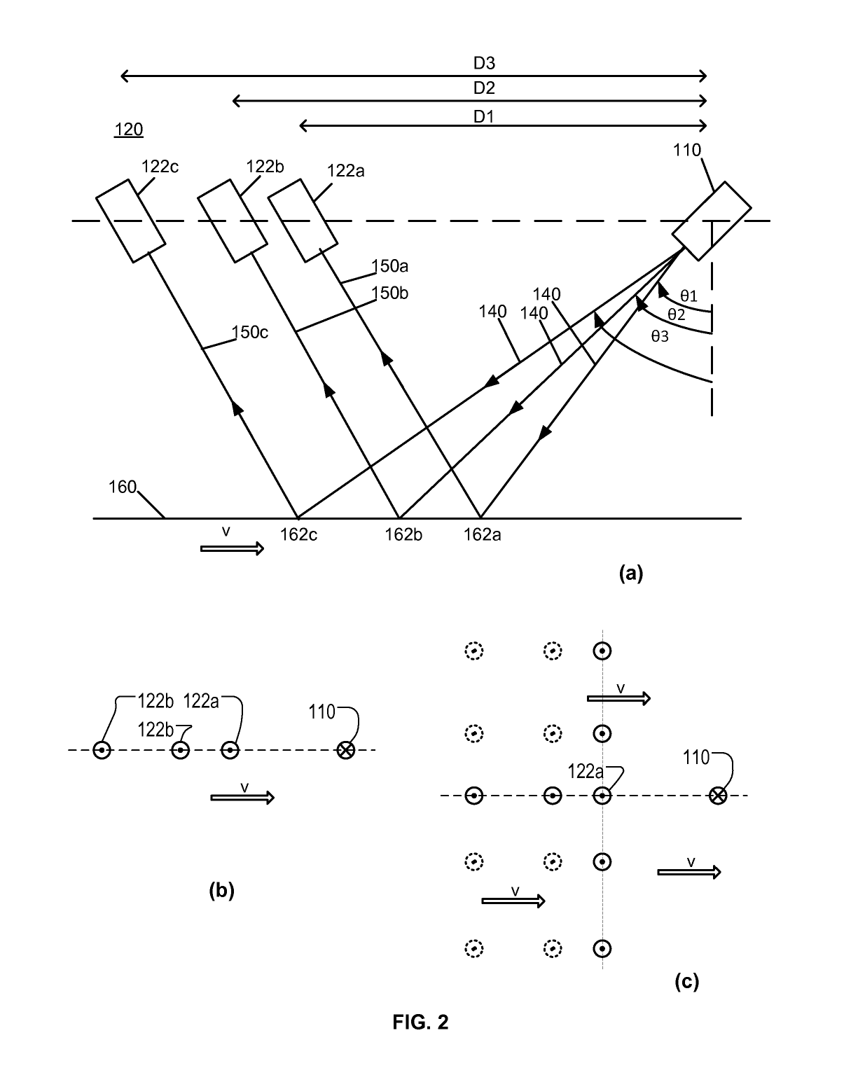

FIG. 2 (a) shows an embodiment of system 100 in which signal detection module 120 comprises a horizontal array of receivers 122a, 122b, 122c etc., such as microphones, spaced horizontally from emitter 110 with different distances D1, D2, D3. As an example, the array of microphones may be installed and mounted on the same horizontal axis as emitter 110 and at a distance in front of emitter 110 equal to twice the approximate height above liquid surface 160, where the incidence angle is 45 degrees. Alternatively, the microphones can be arranged in the form of a vertical array to cover the same range of angles of incidence. Each microphone 122a etc. will receive acoustic signals 150a etc. which have been reflected from a different area 162a, etc. within the insonified elliptical zone of the surface. The size of this insonified zone is determined by the distance to the liquid surface from the emitter transducer, the directivity of the acoustic signal (that is the ratio of the acoustic wavelength to the transducer dimension λ/d) and the incidence angle. For a stable operation, the dimensions of this zone should be chosen to be comparable to the correlation radius of the dynamic water surface roughness. The distance between the transducer and the water surface is chosen to satisfy the far-field conditions, i.e. Lₐ>>2d²/λ where Lₐ is the reflected path length.

A target area on the surface from which a dominant acoustic signal is received at a particular receiver is designed to be small in relation to a dominant spatial scale of said localised fluctuations at the liquid surface. Various considerations can be taken into account to design a practical system in which the area measured is small. First, the beam of sound projected can be is relatively directional, as already described. The amplitude of the emitted sound pressure thus strongly depends on the angle of incidence which is maximum in the direction of specular reflection to the receiver(s). Secondly, the area of the flow surface which carries key phase information about the water surface elevation is small by designing the system to exploit the Fresnel zone effect. According to this effect, sound reflections produced by the parts of the illuminated surface, which are much farther than the wavelength from the point of specular reflection, do not influence strongly the phase of the recorded signal and simply cancel out at the reception point. For this purpose the acoustic wavelength is carefully selected to minimise the Fresnel zone dimensions. The acoustic wavelength may be less than 15 cm, less than 10 cm for example. Thirdly, the characteristic spatial period of the flow surface roughness is assumed to be large in comparison with the acoustic wavelength, so that any reflections from outside the Fresnel zone are deemed to be uncorrelated with the signal received through the angle of specular reflection. The frequency of sound can be carefully selected to ensure that, and phase comparisons can incorporate a sufficient number of cycles to eliminate uncorrelated signal components.

Implementing a plurality of receivers allows for analysis of acoustic data reflected from different areas of the surface and allows for water surface roughness with different correlation radii to be analysed. Additionally, a plurality of receivers arranged along a horizontal axis allows for mean surface gradient deduction by measurement of reflected path-length from emitter 110 to each respective receiver of receiver 120. The distances D1, D2, D3 etc. are chosen such that each possible paring of receivers give rise to a unique separation between them. For example, four microphones may have six possible parings. Each receiver has an associated channel to output its received signal to processing module 130.

As shown in the plan views of FIGS. 2 (b) and (c), different arrangements of the plural receivers and the source can be devised, according to the types of measurement desired, the costs and so forth. In (b) the receivers 122a to 122c are shown spaced away from emitter 110 along a line parallel with the general flow direction of the liquid being monitored. They could be arranged transversely or obliquely to the flow direction if desired. In FIG. 2 (c) a larger number of receivers are arranged in a two-dimensional grid pattern, so as to measure at various points across the stream. A simply ‘crosshairs’ arrangement can be provided, as shown in solid lines, or a more elaborate array of receivers can be provided as indicated by the dotted receivers. The emitter in these examples is shown to one side of the receiver array, but can be placed within it, for example at the centre of a crosshair or grid arrangement. Such an arrangement may be more compact. The emitter in that case may point vertically, or may comprise a number of emitters inclined outward from vertical. For each receiver, the received acoustic signals of course are reflected from a target point or area mid-way between the receiver and the source, as seen in the side view of FIG. 2(a). Therefore the overall surface area sampled by the small target areas is half the size (in each dimension) of the array of receivers.

In one embodiment, processing module 130 is triggered to acquire acoustic data in packets at a frequency high enough to capture surface fluctuation but low enough to conserve memory and processing power. The triggering frequency depends on the nature of the surface fluctuations, which may for example be between 1 Hz and 500 Hz. In one embodiment, the triggering frequency is 100 Hz and the number of acquired sinusoidal periods of data for each trigger is greater than 10. In a simple embodiment, as mentioned above, the emitter 110 emits a continuous sine wave, whose phase and frequency are stable over the time period between sending and receiving acoustic signals from the liquid surface. In an alternative embodiment, the emitter 110 is triggered to emit signals only in packets, synchronised with the received packets. This may be desired for example to conserve energy, and also to permit other uses of the transducer between packets. Whether the emission of the acoustic signals is continuous or broken into packets, the emitting and receiving modules must be synchronised so that the phase of the sent and received signals can be compared with suitable accuracy. As one option, the sine wave may be continuously generated, so as to be available for comparison with the received signal, while its amplification and output to the emitting transducer is gated so that the acoustic signal is only emitted in packets.

The processing module 130 may be operable to acquire a packet (as an example, each packet may be 1 ms) of acoustic data at each trigger from receiver 120 and determine a phase shift of each acoustic signal between the emitted signal and the received signal. Processing module 130 is operable to sample the acoustic data at a frequency greater than the Nyquist frequency of twice the frequency of the emitted signal. The sampling frequency may be at least ten times the emitted acoustic signal frequency and in one embodiment may be 1 MHz. Processing module 130 may also be operable to band-pass filter each packet of acoustic data to isolate the transmission frequency of emitter 110, and to analyse each packet of acoustic data to extract the phase shift between the emitted and received signals. There are a number of means to determine the phase shift between the emitted and received signals, for example: the ‘product-to-sum’ trigonometric identities; a phase measurement of the cross-correlation between the two harmonic signals; or Hilbert transforms of the sent and detected acoustic signals; or the dot product method. It is understood that the processing module 130 is not limited by using a particular means of determining the phase shift between the emitted and received signals. Instead, processing module 130 is interpreted to cover any means which may be employed to determine a phase shift between the emitted and received signals.

For each packet, processing module 130 is operable to average the phase shift measured and unwrapped at different points within the packet, to give a phase shift value for that packet. The instantaneous phase of the received signal at each microphone is thereby known for each packet. Since the packet triggering frequency is known, a time can be associated with each phase measurement. The processing module may be operable to provide a time series of phase shifts, from which phase variations representing surface fluctuations can be observed.

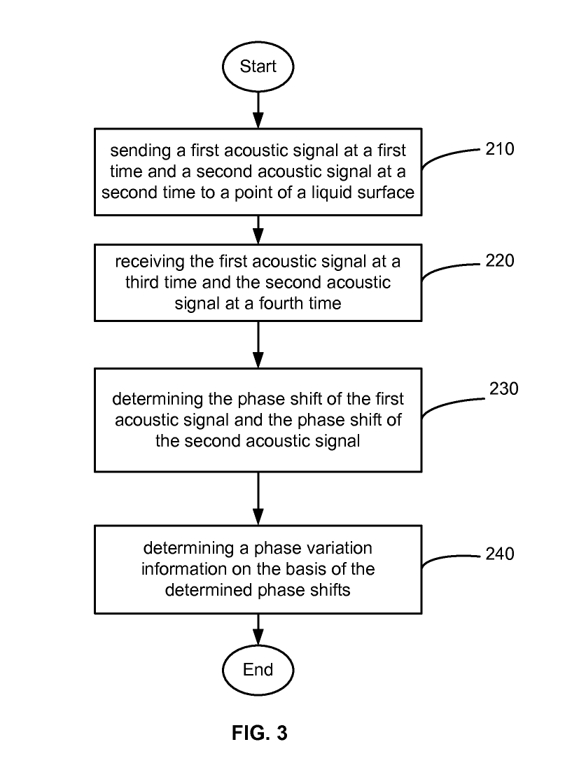

FIG. 3 is a flowchart illustrating the general principle of detecting liquid surface fluctuation with reference to the components disclosed in system 100. At step 210, emitter 110 can send acoustic signals 140 and 150 towards the point 162 of the liquid surface 160 at a first time and a second time, respectively.

At step 220, receiver 120 receives acoustic signals 140 and 150 reflecting back from the point 162 at a third time and a fourth time, respectively.

At step 230, processor module 130 determines a first phase shift of the first acoustic signal and a second phase shift of the second acoustic signal. The first phase shift indicates a time-dependent phase shift of the first acoustic signal between the first time and the third time. The second phase shift indicates a time-dependent phase shift of the second acoustic signal between the second time and fourth time.

At step 240, processor module 130 determines phase variation information on the basis of the first phase shift and the second phase shift. If the liquid surface 160 is stationary (or at least is at the same place when the two acoustic signals are reflected), the value of the first phase shift is same to the value of the second phase shift. Consequently, the value of the phase variation is zero and indicates that there is no fluctuation at point 162.

If the liquid surface 160 displaced vertically, the value of the first phase shift is different with the value of the second phase shift. Consequently, the value of the phase variation is altered due to a change in acoustic signal transmission length. As a result, the phase variation is capable of indicating the surface fluctuations on an arbitrary scale and thus allowing emitter 110 and receiver 120 to be positioned anywhere above the air-water interface.

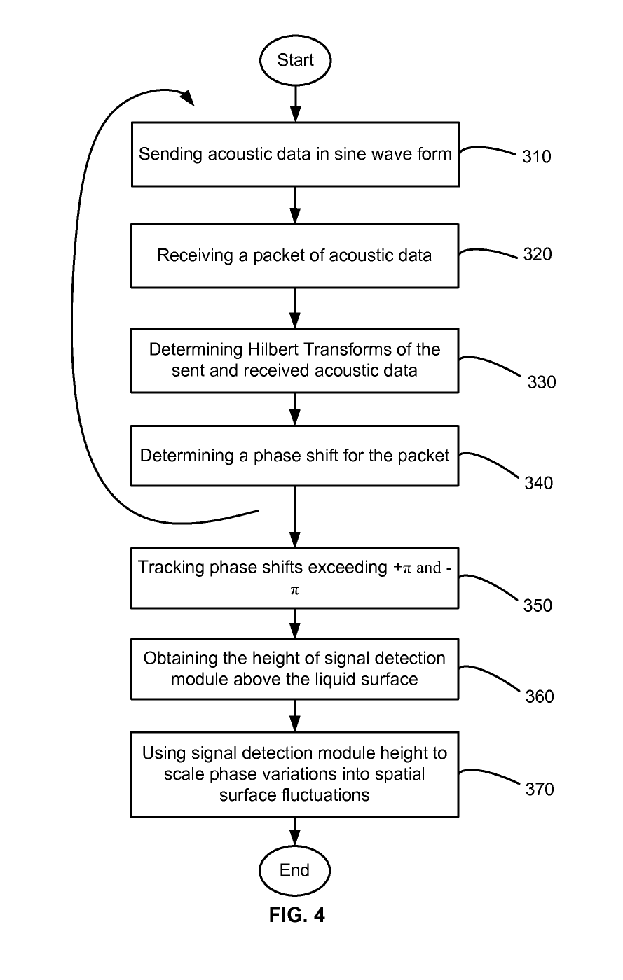

FIG. 4 is a flowchart of a method 300 comprising an embodiment of the invention based on the method 200 described above. In exemplary method 300, steps 310-340, and optionally further steps, are repeated in a continuous loop, while surface fluctuations are to be measured. At step 310, emitter 110 emits acoustic signals in sine wave form. The signals may be emitted as a continuous sine wave or in discrete packets. At 320, receiver 120 is triggered synchronously with the emitter and it receives a packet of acoustic data.

At step 330, processing module 130 calculates Hilbert Transforms of the sent and received acoustic data. The Hilbert Transforms of the sent acoustic signal Vₛ(t) and the received acoustic signal Vᵣ(t) are defined by the following:

Vₛ(t)=Aₛ(t)e^{iω}^{ₛ}^{t+iφ}^{ₛ}

Vᵣ(t)=Aᵣ(t)e^{iω}^{ₛ}^{t+iφ}^{ₛ}^{+iΔφ(t)}, respectively.

Here Aₛ and Aᵣ are the amplitudes of the sent and received acoustic data respectively, ωₛ is the emitter 110 excitation frequency, and φₛ is the phase of the sent acoustic data at time t=0.

At step 340, processing module 130 determines the phase shift for each packet of acoustic data from the Hilbert Transforms. This is done by taking the natural logarithm of the ratio of the analytic signals, the imaginary part IM of this being the time dependent phase shift, Δφ(t), between the sent and received acoustic data:

$$( Δ ϕ ( t ) ) = IM [ log ( \frac{{V}_{r} ( t )}{{V}_{s} ( t )} ) ]$$

For each packet of acoustic data, the calculated phase shifts are averaged to give a single phase shift for that packet.

Since the packet triggering frequency is known, a time can be associated with each phase measurement. Processing module 130 can thus form a time series of phase fluctuations between +π and −π.

At step 350, processing module 130 tracks the phase gradient and its sign of each phase fluctuation so that phase differences that exceed +π and −π can be extracted. These phase differences are associated with surface height fluctuations exceeding acoustic wavelength λ. In one embodiment, the acoustic wavelength of the acoustic signal from the emitter 110 is 7.6 mm. Tracking phase differences greater than +π and −π is therefore important for tracking surface height fluctuations greater than a few millimetres. Processing routines, for example ‘unwrapping’ functions in Matlab, for example, are readily available to implement this function to follow the phase variations over a range greater than ±π.

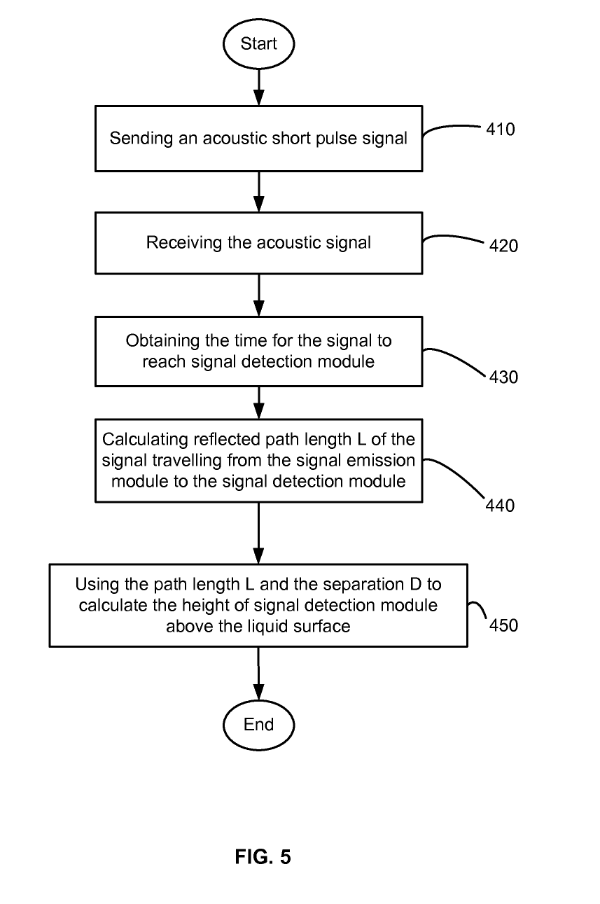

At optional step 360, processing module 130 can obtain the height of receiver 120 above the liquid surface so that the arbitrarily scaled phase fluctuations so far calculated can be scaled as required. Where the height of the receiver 120 above the surface is unknown, the height may be obtained by processing module 130 in accordance with an exemplary method as described below. FIG. 5 illustrates such a method. At step 410, emitter 110 sends an acoustic short pulse signal to the liquid surface 160. At step 420, receiver 120 receives the acoustic signal. At step 430, processing module 130 obtains the time for the acoustic signal travelling from emitter 110 to receiver 120. At step 440, processing module 130 calculates the reflected path length of the acoustic signal travelling from emitter 110 to receiver 120, using the known value for the speed of sound in air. At step 450, since the distance between the emitter 110 and the receiver 120 is known, the processing module 130 can use the distance and the reflected path length calculated at step 440 to calculate the height of receiver 120 above the liquid surface, using the Pythagoras theorem.

Returning to FIG. 4, at step 370, the measured height is used to calculate a scale factor for use in converting measured phase variations (measured by angle) into liquid surface height variations (measured in millimetres). Details of this calculation will be given below.

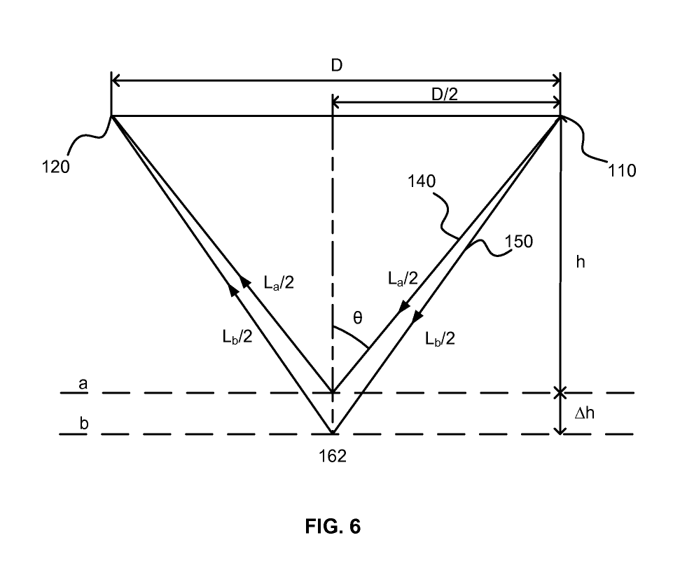

Referring to the method of FIG. 5 and also the geometry illustrated in FIG. 6, the spatial surface fluctuation Δh is calculated according to:

$$Δ h = \sqrt{{( \frac{{L}_{b}}{2} )}^{2} - {( \frac{D}{2} )}^{2}} - h$$

where h is the height of receiver 120 above surface 160, D is the distance between emitter 110 and receiver 120, and L_{b} is the reflected path length of the acoustic signal at one time. L_{b} can be given by:

L_{b}=ΔL+Lₐ,

where Lₐ is the reflected path length of the acoustic signal at another time, and ΔL is the change of the two reflected path lengths, given by:

$$Δ L = - \frac{Δ ϕ λ}{2 π} ,$$

where λ is the acoustic wavelength, and

$${L}_{a} = 2 \sqrt{{( \frac{D}{2} )}^{2} + {h}^{2}}$$

Therefore, the spatial surface fluctuation Δh is linearly related to the phase fluctuations by:

$$Δ h = - \frac{Δ ϕ λ}{2 π} cos ( θ - Δ θ ) ,$$

where θ is the incidence angle of the emitter 110 and Δθ is the deviation from the incidence angle. Since Δθ<<θ, the relationship is thus:

$$Δ h = - \frac{Δ ϕ λ}{2 π} cos ( θ )$$

This last equation shows the scaling required for converting a phase variation to a height variation. At step 370, processing module 130 uses this result to scale phase fluctuations into spatial surface fluctuations. Therefore, it can be seen that a time-series for surface fluctuations can be obtained.

The steps 350-370 can be performed in the same repeating loop as steps 310-340, or they may be deferred to an offline processing step, based on a recording of the phase shifts made in step 340. This is a matter of design choice, depending whether the apparatus is required to report height fluctuations in real time, or the measurements are required only for offline analysis. The height measurement step 350 can be repeated at intervals, which may for example be longer intervals than the intervals between the packets for the steps 310-340. The height measurement data, if it varies over time, can be recorded in association with the phase shift data for the packets, to allow steps 360 and 370 to be performed at a later time. In principle, one could also store the received acoustic data and perform the phase comparison (by Hilbert transform or by other means) offline. To calculate and store the phase shifts (or phase variations) in real time will normally require far less storage and data handling.

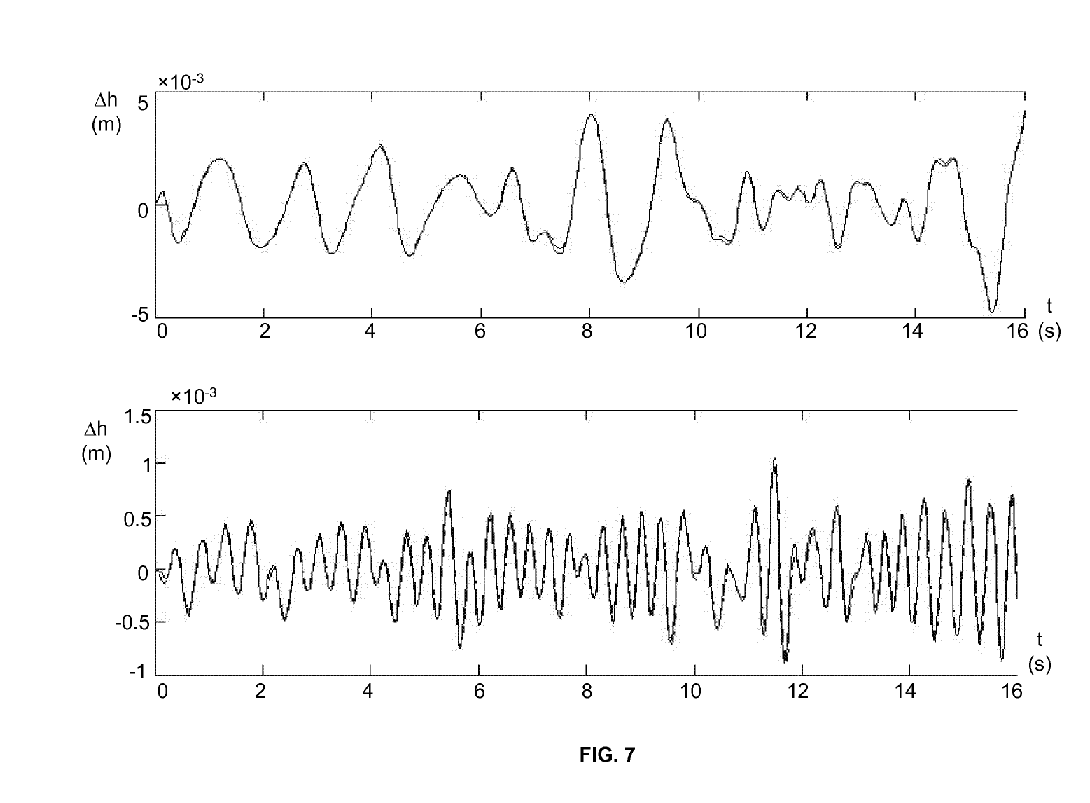

FIG. 7 shows two sets of graphs with each graph illustrating the water surface fluctuation Δh in 10⁻³ m over time t in seconds as measured by a conventional conductance probe (solid trace) and by an acoustic probe forming an embodiment of the present invention (dashed trace). The conventional conductance probe in the experiment was a Churchill Controls 0.25 mm, 2-core conductance probe. From each of the graphs shown in FIG. 7, it can be seen that, although there are two traces, they follow one another closely. This confirms that, at least under the test conditions, the water surface fluctuation Ah as measured from a phase variation substantially corresponds to the water surface fluctuation Δh as measured from conventional conductance probes known in the art.

Analysis of an individual time series allows for calculation of spectral and/or statistical parameters of the surface fluctuations. As an example, the root mean square wave height of the liquid surface can be calculated. This is a very useful characteristic that can be used to determine various hydraulic quantities such as flow depth, mean flow velocity, turbulence intensity, hydraulic roughness and boundary shear stress. A spatial spectrum from each microphone may also be calculated which is believed will yield further details of the hydraulic conditions.

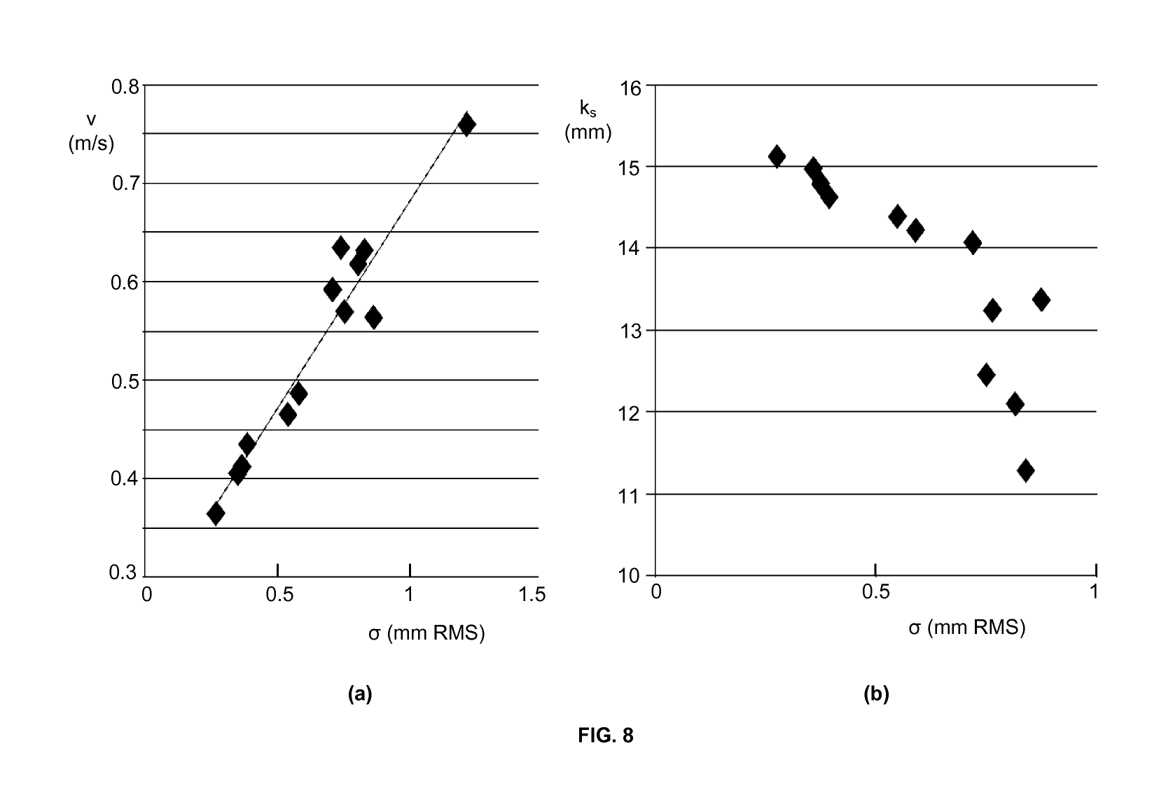

FIG. 8(a) shows experimental results comparing the root mean square wave height of the liquid surface (horizontal axis), measured using the new acoustic method, and mean flow velocity v (vertical axis) in an experimental flowing stream. The strong correlation between the two variables implies that the RMS wave height can be used to estimate the mean flow velocity in a real water course.

Similarly, FIG. 8(b) is a plot of the measured RMS wave height against the hydraulic resistance coefficient (kₛ) which is a standard measure of the hydraulic roughness of an open channel. The hydraulic roughness of an open channel is related to the roughness of the channel bed, as described for example in ‘Experiments with Fluid Friction in Roughened Pipes’ by Colebrook and White in Proceedings of the Royal Society of London, Series A, Mathematical and Physical Sciences 161(906): 367-381. Again, a strong correlation can be observed which implies that the acoustic wave height measurement can be used to estimate hydraulic roughness in a real water course.

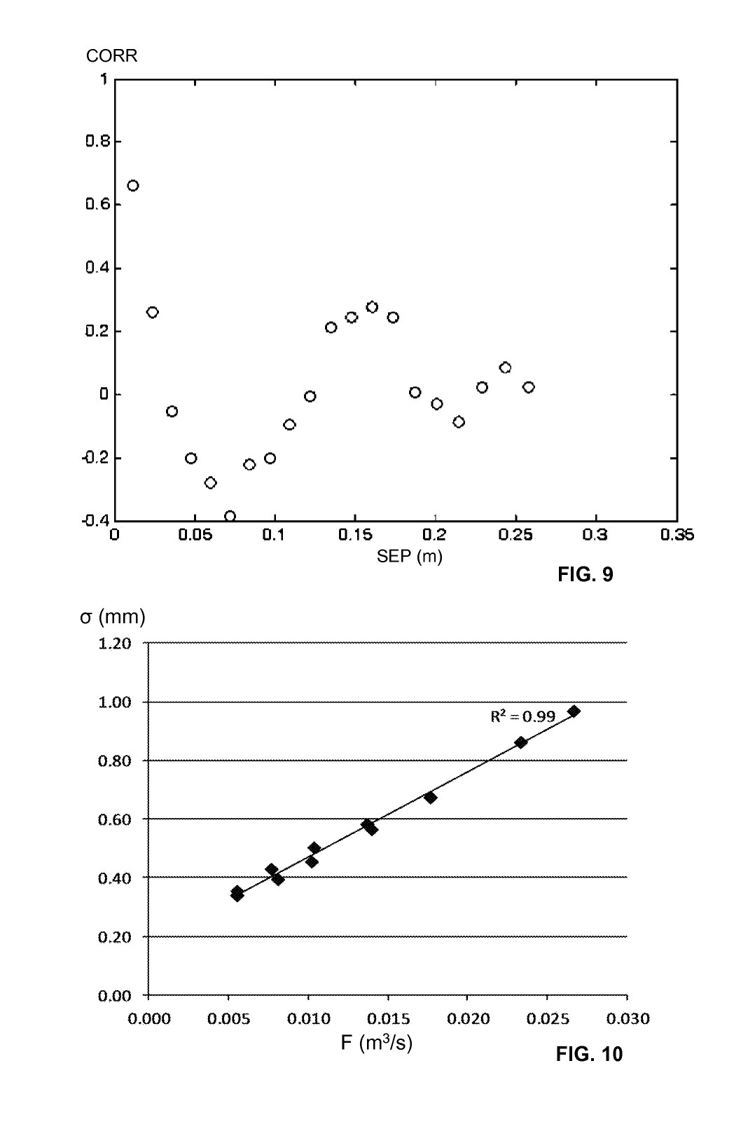

FIG. 9 is a graph showing correlation coefficients CORR observed between the acoustic signals measured by a pair of receivers (microphones) separated by a different distance SEP. The correlation function when SEP=0 is 1 by definition. As the separation increases, the plotted points trace a correlation function which depends on the characteristics of the surface fluctuations in the observed conditions. In the conditions illustrated, a ‘correlation radius’, defined for example as the separation SEP at which correlation drops to 0.1, is around 2-3 cm. As the separation increases, there is a negative peak (anti-correlation) around 7 cm, a zero around 12 cm, a positive peak around 16 cm and so on. Using the apparatus described above to calculate the correlation function, by measuring correlation at a number of different separations, another tool is provided for analysis of water surface correlation radius, which can be used to determine various hydraulic quantities such as flow depth, mean flow velocity, turbulence intensity, hydraulic roughness and boundary shear stress. The correlation function can be calculated in addition to direct recording of the surface fluctuations from one or more of the receivers involved.

The correlation radius in a given situation also gives an idea of the radius of the insonified zone that will give the best combination of responsiveness and freedom from spurious signals, when designing or adjusting the apparatus. Referring again to FIG. 2, it will be recalled that measurement of correlation at different separations can be facilitated by providing an array of receivers with different spacings, all receiving simultaneously. A certain number of microphones, if appropriately spaced, can be selected and paired to give a much greater number of unique separations between them, so as to obtain sufficient samples separations to estimate the correlation function for the intensity of the acoustic field scattered by a water surface. In an alternative embodiment, the correlation at different separations can be measured sequentially, using a pair of receivers with variable separation. The separations in the example described are assumed to be in a horizontal in this example, but that is not necessarily so.

As already illustrated in FIG. 2 (c), an additional receiver array can be provided orthogonal to the first (so they form a cross), or even a grid of receivers. This allows for measurements to be spatially distributed in two dimensions across the surface, allowing 3-D surface properties to be quantified rather than just 2-D.

Further to the above discussion of a spatial correlation function by analysis of the temporal correlation peaks between pairs of receivers, one can also measure the temporal lag (time delay) at which this peak occurs. Where it is the case that that the surface roughness is predominantly due to turbulence and not extraneous factors such as wind or vibration, this temporal lag can be used to obtain a second measurement of flow velocity (additional to the empirical relationships presented previously). Since the separation of the two specular reflection points is known (half the separation of the receivers), a flow velocity can be calculated from the spatial separation and the temporal lag between the phase shift variations at two microphones (receivers). This can be performed for multiple microphone pairs in order to reduce error. Similarly Doppler techniques can be used, as already mentioned.

We could also mention that the spatial correlation function allows us to determine the characteristic spatial period, which we find to scale very similarly to the wave height in response to a change in hydraulic conditions, and therefore also correlates with the flow depth, velocity, discharge etc.

Experiments confirm the relationships described above and confirm utility of the described system for investigating and/or monitoring hydraulic flow conditions in real applications, thanks to the relationships between flow conditions and surface structure. A change in bed structure should also cause a noticeable effect in the surface shape. We have also seen that the surface pattern seems to respond to changes in the bed transport, giving the potential for the sediment transport rate to be measured remotely.

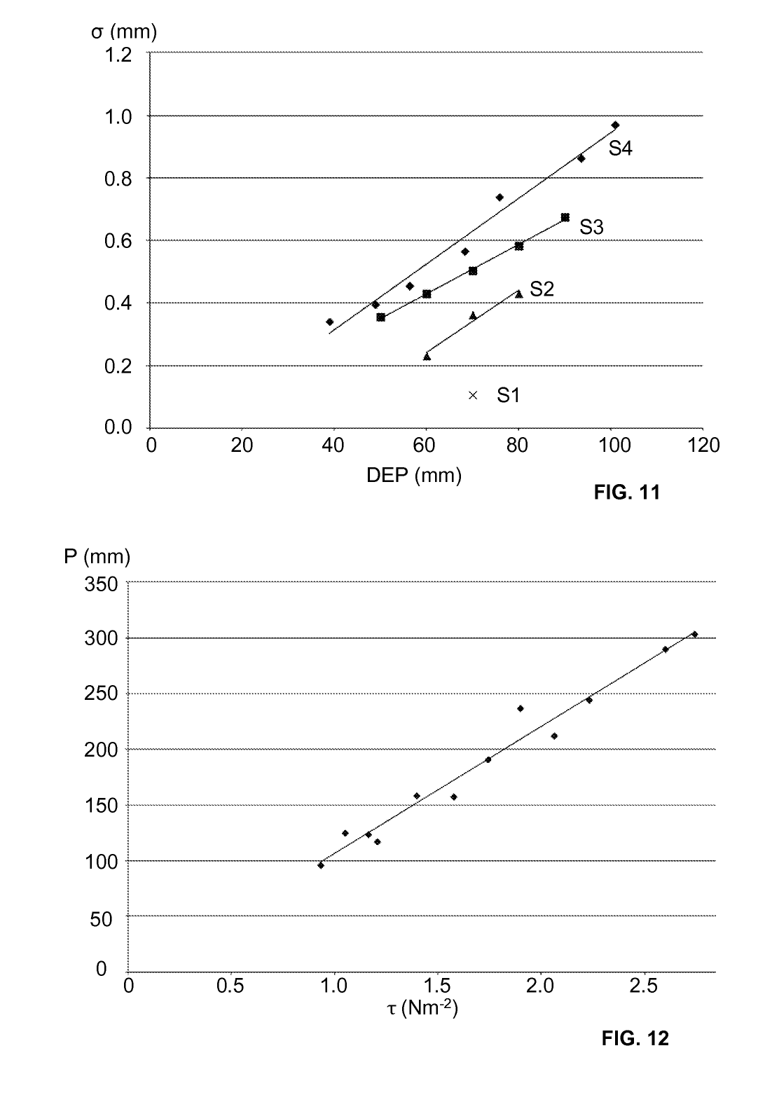

FIGS. 10 to 12 show additional experimental results illustrating the above utility. FIG. 10 shows a relationship between measured surface roughness (RMS wave height) a and the (volumetric) flow rate of water in a channel. FIG. 11 shows relationships between surface roughness a and the depth of flowing water DEP. The experiment was repeated for a number of different bed slopes (pipe gradients) S1, S2, S3, S4, showing that the surface characteristics can be used to distinguish different bed slopes also. FIG. 12 shows a relationship between roughness spatial period P bed shear stress T. The bed shear stress is related to sediment transport. In all the graphs illustrated, the measured points fit the linear relationships very closely.

In conclusion, the acoustic instrument described above can be termed a ‘spatiotemporal acoustic wave-monitor’ since it measures the spatial and temporal properties of the surface waves. Previously, (to our knowledge) this measurement could only be achieved by conductance probes which are very invasive, or by particle image velocimetry which is very expensive. The novel spatiotemporal wave monitor can then be used to understand the meaning behind the observed spatiotemporal flow surface properties, and thereby infer highly valuable information about the flow, which previously could not be remotely measured.

As used in this application, the terms “component”, “module”, “system” and the like are intended to refer to a computer-related entity, either hardware, firmware, a combination of hardware and software, or software in execution. For example, a component can be, but is not limited to being, a process running on a processor, an object, a code module, a thread of execution, a program, and/or a computer. By way of illustration, both an application running a computing device and the computing device can be a component. One or more components can reside within a process and/or thread of execution and a component can be localised on one computer and/or distributed between two or more computers. In addition, these components can be executed from various computer readable media having various data structures stored therein. The components can communicate by way of local and/or remote process such as in accordance with a signal having one or more data packets (e.g. data from one component interacting with another component in a local system, distributed system, and/or across a network such as the Internet with other systems by way of signal).

While specific embodiments of the invention have been described above, it is to be understood that the embodiments described herein can be implemented in hardware, software, firmware, middleware, microcode, or any combination thereof. For example, the invention may take the form of a computer program containing one or more sequences of machine-readable instructions which, when executed by a computer, control the components of a system described above to perform a method described above.

For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

When the embodiments are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

The term “comprising”, “including” and the like as used in the claims does not exclude other elements or steps. The term “a” or “an” as used in the claims does not exclude a plurality.

The methods described above are not limited by the order of acts, as some acts can, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts can be required to implement a methodology in accordance with one or more embodiments.

The descriptions above are intended to be illustrative, not limiting. Thus it will be apparent to one skilled in the art that various modifications may be made to the invention as described without departing from the spirit and scope of the invention.

1. A method for measuring dynamic characteristics of an interface between a first fluid and a second fluid, the method comprising:
sending acoustic signals from an acoustic source to at least one target area on the interface;
receiving said acoustic signals at an acoustic receiver after reflection from the target area; and
processing the received signals to measure a phase shift between the sent and received acoustic signals, the measured phase shift varying over time; and
using variations in the phase shift to indicate fluctuations over time in a position of the fluid interface in the target area.

2. The method as claimed in claim 1 wherein:
the first fluid is a gas and the second fluid is a liquid;
the interface being a free surface of the liquid;
the acoustic source and the acoustic receiver being positioned above the free surface of the liquid; and
the variations in the phase shift being used indicate fluctuations over time in a height of the liquid surface.

3. The method as claimed in claim 2 wherein:
the liquid is flowing; and
the method further comprises deriving from the measured variations in the phase shift a characteristic of the liquid, the characteristic being at least one of surface roughness, wave height, flow depth, flow velocity, volumetric flow rate, shear stress, and sediment transport.

4. The method as claimed in claim 1, wherein:
the sent acoustic signals comprise a harmonic sine wave; and
the processing comprises comparing phases of the sent acoustic signals and the received acoustic signals over several cycles of the sine wave to obtain a measurement of the phase shift at a given time.

5. The method as claimed in claim 1, wherein the phase shift is determined on the basis of Hilbert transforms of data representing the sent acoustic signals and the received acoustic signals.

6. The method as claimed in claim 1, comprising:
arranging a plurality of acoustic receivers at different positions relative to the acoustic source so as to receive acoustic signals that have reflected from different target areas on the interface; and
processing the received acoustic signals so as to measure a time-varying phase shift corresponding to each of the target areas.

7. The method as claimed in claim 6, wherein the plurality of acoustic receivers are spaced to allow different separation distances between different pairs of the acoustic receivers and different separation distances between different pairs of the target areas.

8. The method of claim 6 wherein the acoustic receivers are spaced in two dimensions so that the different target areas are spaced in two dimensions over the interface.

9. The method as claimed in claim 6, further comprising measuring a temporal lag between fluctuations measured for different target areas.

10. The method as claimed in claim 1, comprising:
determining a wave height at the target area on the basis of the measured variations in the phase shift, a known separation of the acoustic source and the acoustic receiver, and a known height of the acoustic receiver relative to the interface.

11. The method as claimed in claim 10, wherein the known height of the acoustic receiver is obtained by measuring a time of flight of an acoustic signal sent from the acoustic source and received by the acoustic receiver after following reflection from the interface.

12. An apparatus for use in measuring dynamic characteristics of an interface between a first fluid and a second fluid, the apparatus comprising:
a signal emitter including an acoustic source that sends acoustic signals from the acoustic source to at least one target area on the interface;
a signal detector including an acoustic receiver that receives the acoustic signals using said acoustic receiver after reflection of the acoustic signals from the target area; and,
a signal processor that processes the received acoustic signals to measure a phase shift between the sent acoustic signals and the received acoustic signals, the measured phase shift varying over time, the variations in the phase shift being usable to indicate fluctuations over time in a position of fluid interface in the target area.

13. The apparatus as claimed in claim 12, wherein:
the first fluid is a gas and the second fluid is a liquid;
the interface being a free surface of the liquid, the acoustic source and receiver being placed above a surface of the free surface of the liquid.

14. The apparatus as claimed in claim 13 wherein:
the liquid is flowing;
the signal processor is arranged to derive from the measured variations in the phase shift a characteristic of the fluid, the characteristic including at least one of: surface roughness, wave height, flow depth, flow velocity, volumetric flow rate, shear stress, and sediment transport.

15. The apparatus as claimed in claim, 12, wherein:
the sent acoustic signals comprise a harmonic sine wave; and
the signal processor is arranged to compare phases of the sent acoustic signals and the received acoustic signals over several cycles of the sine wave to obtain a measurement of the phase shift at a given time.

16. The apparatus as claimed in claim 12, wherein the phase shift is determined on the basis of Hilbert transforms of data representing the sent acoustic signals and the received acoustic signals.

17. The apparatus as claimed in claim 12, wherein:
the signal emitter comprises a plurality of acoustic receivers arranged at different positions relative to the acoustic source to receive acoustic signals that have reflected from different target areas on the interface; and
the signal processor processes the received acoustic signals so as to measure a time-varying phase shift corresponding to each of said target areas.

18. The apparatus as claimed in claim 17, wherein the plurality of acoustic receivers are spaced to allow different separation distances between different pairs of the acoustic receivers, and different separation distances between the different pairs of target areas.

19. The apparatus of claim 17 wherein acoustic receivers are spaced in two dimensions so that the different target areas are spaced in two dimensions over the interface.

20. The apparatus as claimed in claim 17, wherein said signal processor measures a temporal lag between fluctuations measured for different target areas.

21. The apparatus as claimed in claim 12, wherein the signal processor determines a wave height at each point on the basis of the variations in phase shift, a known separation of the acoustic source and the acoustic receiver and a known height of the acoustic receiver relative to the interface.

22. The apparatus as claimed in claim 15, wherein the signal processor obtains said known height of the acoustic receiver automatically by measuring a time of flight of an acoustic signal sent from the acoustic source and received by the acoustic receiver after reflection from the interface.

23. A processor arranged to receive data representing acoustic signals and to perform the processing step of the any method as claimed in claim 1.

24. A computer-readable medium comprising instructions which, when executed by a computer, can perform the processing step of the method as claimed in claim 1.
